(19) United States
(12) Patent Application Publication
(10) Pub. No.: US 2019/0292621 A1
(43) Pub. Date: Sep. 26, 2019

(54) METHOD FOR PRODUCING PLAIN-BEARING COMPOSITE MATERIALS, PLAIN-BEARING COMPOSITE MATERIAL, AND SLIDING ELEMENT MADE OF SUCH PLAIN-BEARING COMPOSITE MATERIALS

(71) Applicant: FEDERAL-MOGUL WIESBADEN GMBH, WIESBADEN (DE)

(72) Inventor: GERD ANDLER, BAD SCHWALBACH (DE)

(21) Appl. No.: 16/301,545

(22) PCT Filed: May 11, 2017
(86) PCT No.: PCT/EP2017/061311

§ 371 Date: Nov. 14, 2018

(30) Foreign Application Priority Data
May 18, 2016 (DE) 10 2016 208 482.8

(51) Int. Cl. C21D 9/40; B32B 15/01; B22D 19/00; C22F 1/08; C22C 13/00; C22C 12/00; F16C 33/12; F16C 33/14

(52) U.S. Cl. CPC C21D 9/40; B32B 15/015; B22D 19/00; C22F 1/08; C22C 13/00; F16C 2220/20; F16C 33/121; F16C 33/124; F16C 33/14; F16C 2202/04; F16C 2204/10; C22C 12/00

(57) ABSTRACT

A method for producing plain-bearing composite materials (30) is provided in which a bearing metal melt (14) is poured onto a belt material (6) of a steel and the composite material (25) of belt material (6) and bearing metal (14) is then subjected to a heat treatment. After the bearing metal (14) has been poured on, the composite material (25) is quenched, followed by an aging operation. A plain-bearing composite material (30) is provided, which has a carrier layer (32) of steel and a bearing metal layer (34) of a cast copper alloy, wherein the bearing metal layer has a dendritic microstructure.

The invention relates to a method for producing plain-bearing composite materials, in which a bearing metal is cast onto a strip material made of a steel and the composite material consisting of the strip material and bearing metal then undergoes a heat treatment. The invention also relates to plain-bearing composite materials and to sliding elements made of such plain-bearing composite materials.

Currently, plain-bearing composite materials are produced by cooling the composite material to room temperature after the bearing metal has been cast, and then subjecting the material to a heat treatment that includes an annealing step, quenching to room temperature and then precipitation hardening (aging). This method sequence is shown schematically in FIG. 1, in which the temperature T of the individual method sections is plotted against time t. and is described, for example, in DE 496 935. RT denotes room temperature (20° C.) and T_{M} denotes the melt temperature.

The annealing step is also referred to as solution annealing, which, in accordance with DIN 17014, means annealing to dissolve precipitated constituents in mixed crystals. For example, in austenitic steels, certain precipitable alloy elements are dissolved in the γ-mixed crystal. By subsequently cooling the material quickly enough, a supersaturated precipitation-hardenable γ-mixed crystal is obtained.

In addition to the annealing temperature, the retention time and cooling rate are important for the grain size achieved after annealing treatment. Very slow cooling, e.g. In the furnace, leads to the γ-phase being converted at a relatively high temperature. However, the number of nuclei formed over unit of time is low whilst the crystallisation speed is high. This creates the conditions for a relatively coarse grain. If cooling is rapid, the microstructure produced is finer because the conversion only takes place at lower temperatures. Alloy additives can hinder grain growth due to the formation of precipitates (see BARTHOLOME E. 1982 Ullmanns Encyklopädie der technischen Chemie. Volume 22, 4th Edition, page 28. Verlag Chemie, Weinheim).

In alloys, solution annealing is also referred to as homogenisation annealing.

Since practically all technical alloys consist entirely or largely of mixed crystals, segregation can be expected to varying extents in cast metals and alloys. However, since the most uniform microstructure possible is always desired in an alloy, this segregation should be eliminated as much as possible. This is done by homogenisation annealing. The heterogeneous, segregated alloy is annealed at the highest possible temperatures until the concentration differences between the crystal edge and core have balanced out as a result of diffusion (see SCHUMANN H. 1989 Metallographie [Metallography], 13th Edition, page 376, Deutscher Verlag für Grundstoffindustrie, Leipzig).

“Aging” involves holding at room temperature (natural aging) or holding at a higher temperature (artificial aging) in order to bring about demixing and/or precipitation from supersaturated mixed crystals. When depleting the supersaturated mixed crystal, precipitation may occur, either regularly (continuously) or irregularly (discontinuously).

Precipitation processes of this kind are important when tempering hardened steel, for example, since martensite is a supersaturated mixed crystal and carbide may also precipitate out. In steels containing alloy elements that form special carbide, the carbides of these elements are precipitated out of the martensite at tempering temperatures of from 450° C. to 650° C. and cause secondary hardening (see BARTHOLOME E. 1982 Ullmanns Encyklopädie der technischen Chemie, Volume 22, 4th Edition, page 34, Verlag Chemie, Weinheim).

Some copper alloys are precipitation-hardenable. For a copper alloy to be precipitation-hardenable, three conditions must be met. The solubility for the alloy components in the solid state must be low, the solubility must reduce as the temperature drops, and the inertia of the establishment of the equilibrium must be high enough for the mixed crystal that is homogeneous at high temperatures to be retained in the solid state following quenching (see. DKI (German Copper Institute), Wärmebehandlung von Kupferwerkstoffen [Heat-treating copper materials], https://www.kupferinstitut.de/de/werkstoffe/verarbeitung/waermebehandlung.html).

DE 10 2005 063 324 B4 discloses a standard method for producing plain-bearing composite materials, in particular for plain-bearing elements such as plain-bearing shells. Said method provides for the following method steps:
casting a copper alloy onto a steel substrate to produce a composite,
thermomechanical treatment by means of the following steps:
at least one first annealing of the composite at 550° C. to 700° C. for two to five hours,
at least one first rolling of the composite, a degree of deformation of from 20 to 30% being implemented,
at least one second annealing at 500° C. to 600° C. for more than one hour.

The first annealing is homogenisation annealing and the second annealing is recrystallisation annealing. In this method, the steel is not aged.

However, a composite material thus produced cannot meet the increased requirements for the strength of plain bearings. The term “strength” covers the terms tensile strength, yield strength and elongation at break.

In light of the above, the object of the invention is to provide a production method for plain-bearing composite materials that can be carried out more quickly and cost-effectively while also resulting in a plain-bearing composite material that has better mechanical properties, in particular higher strength and greater hardness.

Another object of the invention is to provide a corresponding plain-bearing composite material and a plain-bearing element produced from said material.

This object is achieved by a method having the features of claim 1.

The method is characterised in that, after the bearing metal has been cast, the composite material is quenched and then an aging process is carried out subsequently.

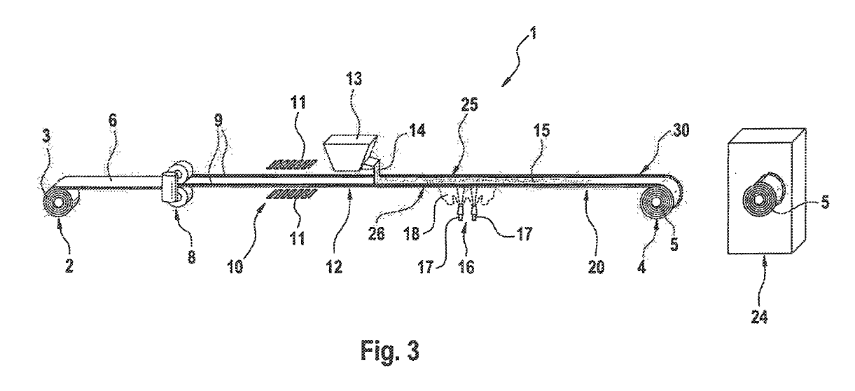

“Subsequently” not only means “immediately afterwards”, but also covers aging at a later point in time, e.g. after the composite material has been coiled up in a bell furnace, as described in relation to FIG. 3.

The heat treatment following the casting thus includes quenching the composite material and the aging process, which is also referred to as aging.

“Quenching” is understood to mean rapid cooling from the melting point to a specified temperature. A quenching process of this kind preferably lasts less than two minutes, particularly preferably less than one minute.

The method is carried out without an annealing step between the quenching and the aging process.

By eliminating the annealing step, the duration of the production method is reduced. Energy consumption and costs for heating the composite material to carry out the annealing step are also reduced.

It has also been found that by combining the casting, the quenching process and the subsequent aging, the mechanical properties of the composite material could be significantly improved.

By casting the hot bearing-metal melt and as a result of the subsequent quenching, the steel undergoes a heat treatment that is similar to a heat treatment for hardening steel. The typical melting points for bearing metals, in particular those made of copper alloys, are from 1000° C. to 1250° C., which corresponds to the range of the annealing temperature of from 1000° C. to 1100° C. typically used to harden austenitic steels.

The hardness of the steel can be set in the range of from 150 HBW 1/5/30 to 250 HBW 1/5/30.

The advantage of the method according to the invention is thus that the casting is used in combination with the melt quenching process in order to harden the steel.

Quenching the bearing-metal melt is also advantageous in that it prevents crystallisation and freezes the disorderly fluid structure of the bearing metal. Segregation can thus barely even occur in the bearing metal, meaning that there is no need for solution annealing for homogenisation purposes and aging can be carried out subsequently.

The frozen disorderly mixed crystal structure as the starting structure for the aging has the advantage whereby, for example, the hardness of the bearing metal can be adjusted across a broad range in a targeted manner by selecting suitable temperatures and durations for the heat treatment. This also applies to other mechanical properties, such as tensile strength and yield strength, to the elongation at break and to the electrical conductivity, which is closely linked with thermal conductivity.

For the aging process, it has been found that a temperature range of preferably 350° C. to 520° C. and preferably a duration of from four hours to ten hours are preferred for the targeted adjustment of the mechanical properties. In this respect, the long durations are preferably combined with the low aging temperatures, and vice versa.

For the bearing metal, the hardness can be set in the range of from 100 to 200 HBW 1/5/30 and the electrical conductivity in the range of from 20 to 50% IACS (International Annealed Copper Standard). In this case, the electrical conductivity is expressed as a percentage of electrical conductivity in pure annealed copper. 100% IACS corresponds to an electrical conductivity of 58·10⁶ S/m. Values of between 380 MPa and 500 MPa can preferably be set for the tensile strength, values of from 250 to 450 MPa can preferably be set for the yield strength and values of from 5 to 35% can preferably be set for the elongation at break.

Preferably the aging process is carried out at a temperature of between 350° C. and 420° C. On one hand, aging in this temperature range leads to only a slight increase in the hardness of the bearing metal compared with the cast state, the achievable hardness being substantially equivalent to the hardness that is similar to conventional methods that include solution annealing.

On the other hand, this measure can set a significantly higher yield strength in the bearing metal compared with the prior art. As a result, the plain-bearing composite material is very well suited for heavy-duty use, e.g. in heavy-duty lorries, construction machines or other heavy-duty commercial and work machines in which said plain-bearing composite material is used for sliding elements, e.g. plain-bearing shells, plain-bearing bushes or sliding segments.

Preferably, the aging process is carried out at a temperature of between >420° C. and 520° C. Aging in this temperature range has the advantage whereby the hardness, tensile strength and yield strength of the bearing metal can be increased considerably compared with the prior art and adjusted in a targeted manner. As a result, the plain-bearing composite material is very well suited to use in the industrial sector, e.g. in valve plates of hydraulic pumps.

The aging process does not influence the hardness of the steel already achieved as a result of the quenching, and so the aging process parameters, such as temperature and holding time, may only be selected in order to adjust the properties of the bearing metal.

The method is advantageous in that it is possible to produce a composite material that has a very hard steel combined with bearing-metal layers of a different hardness.

Preferably, an austenitic steel is used as the steel, a steel having a carbon content of from 0.15 wt. % to 0.40 wt. % particularly preferably being used. Example steels and their compositions are set out in Table 1 below.

TABLE 1

| Steel description | | Chemical composition (wt. %) | | | | | | | | |
|---|---|---|---|---|---|---|---|---|---|---|
| | Material | | Si | | | | | | | Cr + Mo + |
| Short name | numbers | C | max. | Mn | P max. | S | Cr max. | Mo max. | Ni max. | Ni max. |

Quality steels

| | | | | | | | | | | |
|---|---|---|---|---|---|---|---|---|---|---|
| C35 | 1.0501 | 0.32 to | 0.40 | 0.50 to | 0.045 | Max. | 0.40 | 0.10 | 0.40 | 0.63 |
| | | 0.39 | | 0.80 | | 0.045 | | | | |
| C40 | 1.0511 | 0.37 to | 0.40 | 0.50 to | 0.045 | Max. | 0.40 | 0.10 | 0.40 | 0.63 |
| | | 0.44 | | 0.80 | | 0.045 | | | | |

Stainless steels

| | | | | | | | | | | |
|---|---|---|---|---|---|---|---|---|---|---|
| C22 E | 1.1151 | 0.17 to | 0.40 | 0.40 to | 0.030 | Max. | 0.40 | 0.10 | 0.40 | 0.63 |
| | | 0.24 | | 0.70 | | 0.035 | | | | |
| C22 P | 1.1149 | | | | | 0.020 to | | | | |
| | | | | | | 0.040 | | | | |

In these steels, the austenitic phase of the steel is frozen by the quenching process.

Preferably, a bearing metal consisting of a copper alloy is cast. It has been found that the mechanical properties of the bearing metal can be adjusted across a broad range if a copper alloy, preferably a precipitation-hardenable copper alloy and in particular a copper-nickel alloy, a copper-iron alloy, a copper-chromium alloy or a copper-zirconium alloy is used as the bearing metal.

Table 2 sets out the compositions of preferred copper alloys.

TABLE 2

| | EN | UNS | | | | | | | | | | | WL | |
|---|---|---|---|---|---|---|---|---|---|---|---|---|---|---|
| | number | number | Cu | Cr | Zr | Ni | Si | Fe | P | Mn | Zn | Other | W/(mK) | State |
| CuCr1Zr | CW106C | C18150 | Remainder | 0.5-1.2 | 0.03-0.3 | | Max | Max | | | | Max | 320 | Pre- |
| | | | | | | | 0.1 | 0.08 | | | | 0.2 | | cipitation- |
| | | | | | | | | | | | | | | hardened |
| CuCr1 | CW105C | C18200 | Remainder | 0.3-1.2 | | | | | | | | | 325 | |
| CuFe2P | CW107C | C19400 | Remainder | | | | | 2.1-2.6 | 0.015-0.15 | | 0.05-0.2 | | 260 | |
| CuNi1P | CW108C | C19000 | Remainder | | | 0.8-1.2 | | | 0.15-0.25 | | | Max | 251 | Pre- |
| | | | | | | | | | | | | 0.1 | | cipitation- |
| | | | | | | | | | | | | | | hardened |
| CuNi1Si | CW109C | C19010 | Remainder | | | 1.0-1.6 | 0.4-0.7 | Max | | Max | | Max | 150-250 | Pre- |
| | | | | | | | | 0.2 | | 0.1 | | 0.3 | | cipitation- |
| | | | | | | | | | | | | | | hardened |
| CuNi2Si | CW111C | C70260 | Remainder | | | 1.6-2.5 | 0.4-0.8 | Max | | Max | | Max | 160 | |
| | | | | | | | | 0.2 | | 0.1 | | 0.3 | | |
| CuNi3Si | CW112C | C70250 | Remainder | | | 2.6-4.5 | 0.8-1.3 | Max | | Max | | Max | 190 | |
| | | | | | | | | 0.2 | | 0.1 | | 0.5 | | |
| CuNi2Si | CS-4 | | Remainder | | | 1.5-2.5 | 0.4-0.8 | Max | | | | Max | | |
| | | | | | | | | 0.7 | | | | 0.5 | | |
| CuZr | CW120C | C15000 | Remainder | | 0.1-0.2 | | | | | | | Max | 310-330 | |
| | | | | | | | | | | | | 0.1 | | |

EN refers to the material number according to the European standard and UNS refers to the material number according to the American standard (ASTM).

Preferably, the quenching process begins immediately after the casting process. By doing so, normal, i.e. uncontrolled cooling is prevented from occurring after the casting process; this would be disadvantageous since the bearing-metal microstructure comes very close to the equilibrium state, which makes it difficult or impossible to carry out the intended precipitation hardening immediately after the casting.

Preferably, the quenching process begins within 15-25 seconds after the casting process.

Preferably, the composite material is quenched to a temperature T₁ of from 150° C. to 250° C. Further cooling to room temperature occurs passively by the material being left to cool. The cooling can also take place when the composite material has been coiled up.

Preferably, the quenching process is carried out at a quenching rate of from 10 K/s to 30 K/s. At a quenching rate lower than 10 K/s, it cannot be ensured that the bearing metal is in a supersaturated mixed crystal state, which would make precipitation hardening difficult or impossible.

A higher quenching rate than 30 K/s is not necessary since tests have shown that quenching rates >30 K/s no longer bring any advantage in terms of the precipitation effect.

The quenching rate should preferably be adapted to the relevant alloy. Preferably, the copper-nickel alloy is quenched at a quenching rate of from 15 K/s to 25 K/s.

Preferably, the copper-iron alloy is quenched at a quenching rate of from 15 K/s to 25 K/s.

Preferably, the copper-chromium alloy is quenched at a quenching rate of from 10 K/s to 20 K/s.

Preferably, the copper-zirconium alloy is quenched at a quenching rate of from 10 K/s to 25 K/s.

The different quenching rates for the individual copper alloys are necessary because, depending on the alloy system, the two-phase area consisting of the α-mixed crystal and the hard particles extends over temperature ranges of different sizes. Consequently, for alloy systems having a broad two-phase area, a higher cooling rate must be implemented in order as far as possible to generate less precipitation during the casting process than in the systems having a narrower two-phase area.

The quenching is carried out using a cooling medium, preferably by means of a quenching fluid, in particular by means of a cooling oil.

Preferably, the quenching fluid is sprayed onto the rear side of the composite material. Spraying onto the rear side, i.e. the steel side, ensures that the steel is quenched first and only then is the bearing metal cooled. This ensures that the desired hardness of the steel is achieved in each case, especially since the hardness of the bearing metal is adjusted anyway by the subsequent aging process.

When producing the plain-bearing composite material, a steel strip is preferably unwound from a roll and continually fed to the individual treatment stations arranged one after the other. The finished plain-bearing composite material is wound up again at the end of the production method and then fed to a separate aging station.

Afterwards, or at a later point in time, the plain-bearing composite material is processed further to form plain-bearing elements, e.g. plain-bearing half-shells, plain-bearing plates, etc. During the further processing, further layers, in particular a sliding layer, are applied as required.

Preferably, the strip material is heated to a temperature T₀ in the range from 900° C. to 1050° C. prior to casting. This preheating is advantageous in that, when cast, the bearing-metal melt can spread fully and uniformly over the entire width of the strip in the liquid state, before solidification takes place.

Preferably, the preheating is carried out by radiant heaters arranged above and/or below the strip material.

Additional preferred method steps are profiling the steel strip prior to casting, i.e. deforming the edge of the steel strip; milling the bearing-metal surface after the bearing metal has been quenched and solidified: and deprofiling, in particular removing edge strips, after aging.

The plain-bearing composite material comprises a steel substrate and a bearing-metal layer consisting of a cast copper alloy and is characterised in that the bearing-metal layer has a dendritic microstructure.

A “dendritic structure” is understood to mean ramified growth shapes of crystals that have a fir tree-like structure and the shape and arrangement of which in the solidification microstructure is highly dependent on the cooling conditions.

The substrate preferably has a hardness of from 150 HBW 1/5/30 to 250 HBW 1/5/30.

The substrate preferably has a hardness of from 190 HBW 1/5/30 to 210 HBW 1/5/30.

The bearing-metal layer preferably has a hardness of from 100 HBW 1/5/30 to 200 HBW 1/5/30.

The bearing-metal layer preferably has a hardness of from 100 HBW 1/5/30 to 180 HBW 1/5/30.

The bearing-metal layer preferably has a tensile strength of from 380 MPa to 500 MPa, particularly preferably from 390 to 480 MPa.

Preferably, the yield strength of the bearing-metal layer is from 250 MPa to 450 MPa.

The elongation at break of the bearing-metal layer is preferably from 5% to 35%.

The copper alloy is preferably a copper-nickel alloy, a copper-iron alloy, a copper-chromium alloy or a copper-zirconium alloy.

The alloy content of nickel is preferably in the range from 0.5 to 5 wt. %, particularly preferably in the range from 1 to 3 wt. %.

The alloy content of iron is preferably in the range from 1.5 to 3 wt. %, particularly preferably in the range from 1.9 to 2.8 wt. %.

The alloy content of chromium is preferably in the range from 0.2 to 1.5 wt. %, particularly preferably in the range from 0.3 to 1.2 wt. %.

The alloy content of zirconium is preferably in the range from 0.02 to 0.5 wt. %, particularly preferably in the range from 0.3 to 0.5 wt. %.

The alloy content of phosphorus is preferably in the range from 0.01 to 0.3 wt. %, the content of manganese is preferably in the range from 0.01 to 0.1 wt. % and the content of zinc is preferably in the range from 0.05 to 0.2 wt. %

The plain-bearing element according to the invention comprises the plain-bearing composite material according to the invention and preferably a sliding layer applied to the bearing-metal layer.

It is also advantageous if the sliding layer consists of a galvanic layer. Galvanic layers are multifunctional materials that are distinguished, among other things, by good embeddability for foreign particles, by run-in properties or adaptation to sliding partners, as anti-corrosion agents and by good dry-running properties in the event of oil loss. Galvanic layers are particularly advantageous when using low-viscosity oils since, in this case, mixed-friction states, in which the aforementioned properties become important, may occur relatively frequently.

The galvanic layer preferably consists of a tin-copper alloy, a bismuth-copper alloy or of pure bismuth.

In the tin-copper alloys, the copper content is preferably 1-10 wt. %. In the bismuth-copper alloys, the preferred copper content is 1-20 wt. %.

Another preferred process is the PVD process, in particular sputtering. Sputtered layers preferably consist of aluminium-tin alloys, aluminium-tin-copper alloys, aluminium-tin-nickel-manganese alloys, aluminium-tin-silicon alloys or aluminium-tin-silicon-copper alloys.

In these alloys, preferably the tin content is 8-40 wt. %, the copper content is 0.5-4.0 wt. %, the silicon content is 0.02-5.0 wt. %, the nickel content is 0.02-2.0 wt. % and the manganese content is 0.02-2.5 wt. %.

According to another embodiment, the sliding layer can consist of a plastic layer. Plastic layers are preferably applied by means of a painting or printing method, e.g. screen or pad printing, by immersion or by spraying.

To this end, the surface to be coated must be suitably prepared by having grease removed and being chemically or physically activated and/or mechanically roughened, for example by sand blasting or grinding.

The matrix of the plastic layers preferably consists of highly temperature-resistant resins such as PAI. In addition, additives such as MoS₂, boron nitride, graphite or PTFE can be embedded in the matrix. The content of additives, individually or in combination, is preferably between 5 and 50 vol. %.

Table 3 gives examples of galvanic sliding layers.

TABLE 3
(information in wt. %)

| | Example | | |
|---|---|---|---|
| | 4 | 5 | 6 |
| Tin | 94 | | |
| Bismuth | | 100 | 95 |
| Copper | 6 | | 5 |

A preferred galvanic sliding layer comprises a tin matrix into which copper particles are embedded, which consist of 39-55 wt. % copper and the remainder tin. The particle diameters are preferably from 0.5 μm to 3 μm.

The galvanic layer is preferably applied to an intermediate layer, in particular to two intermediate layers, the first intermediate layer consisting of Ni and the second intermediate layer thereon consisting of nickel and tin. The NI content of the second intermediate layer is preferably 30-40 wt. % Ni. The first intermediate layer preferably has a thickness of from 1 to 4 μm and the second intermediate layer preferably has a thickness of from 2 to 7 μm.

Table 4 gives examples of sputtered layers.

TABLE 4
(information in wt. %)

| | Example | | | | |
|---|---|---|---|---|---|
| | 7 | 8 | 9 | 10 | 11 |
| Al | Remainder | Remainder | Remainder | Remainder | Remainder |
| Sn | 22 | 35 | 25 | 10 | 20 |
| Cu | 0.7 | 1.2 | 0.7 | 0.5 | 0.5 |
| Si | | | 2.5 | | 1.5 |
| Mn | | | | 1.5 | |
| Ni | | | | 0.7 | 0.7 |

Table 5 gives examples of plastic sliding layers.

TABLE 5
(information in vol %)

| | Example | | | | |
|---|---|---|---|---|---|
| | 12 | 13 | 14 | 15 | 16 |
| PAI | 70 | 80 | 70 | 75 | 65 |
| MoS₂ | 30 | | | | 20 |
| BN | | 20 | | | |
| Graphite | | | 30 | | |
| PTFE | | | | 25 | 15 |

All the aforementioned sliding layers can be combined with the bearing-metal layers from the copper alloys.

The plain-bearing element is preferably formed as a plain-bearing shell, a valve plate or a sliding segment, e.g. a sliding guide rail.

Example embodiments will be explained in more detail below on the basis of the drawings:

FIG. 1 is a schematic illustration of the production method according to the prior art,

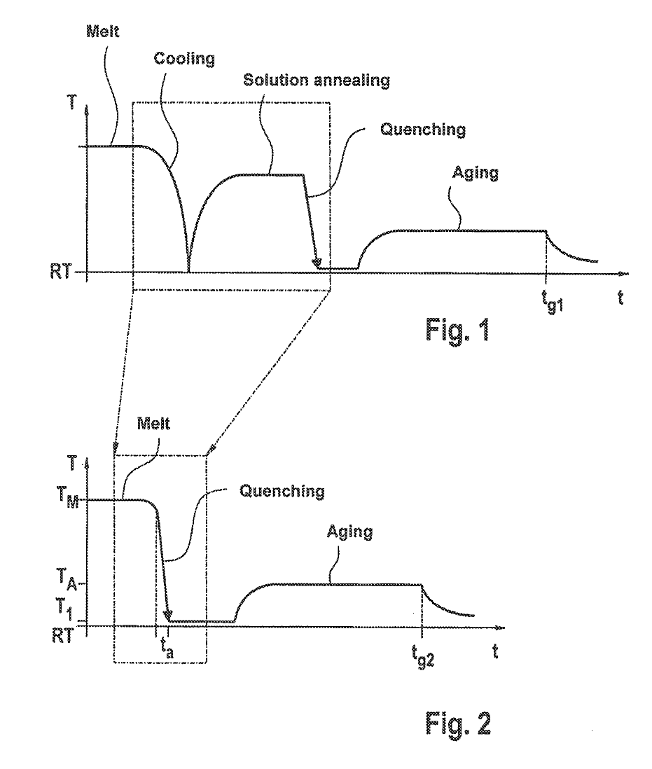

FIG. 2 is a schematic illustration of the method sequence according to the invention,

FIG. 3 is a schematic view of a strip casting system according to the invention,

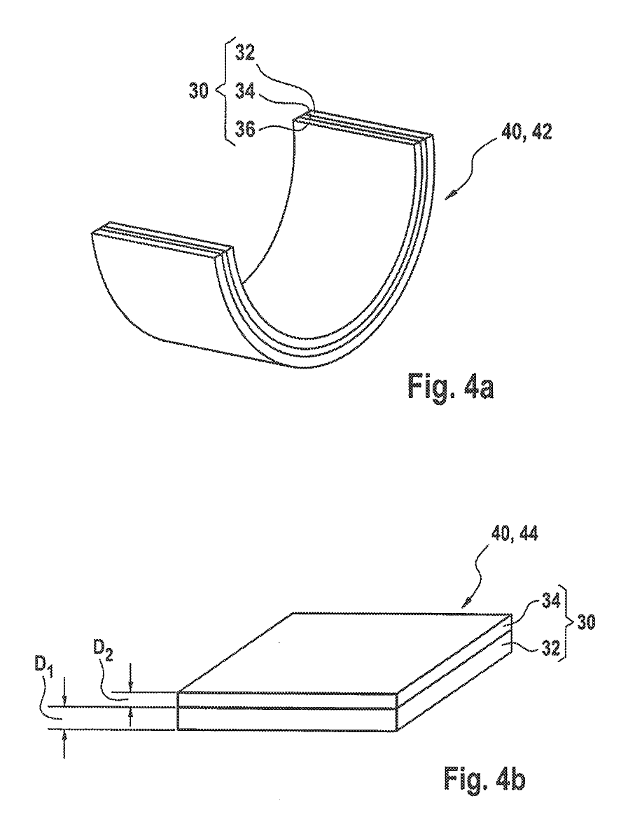

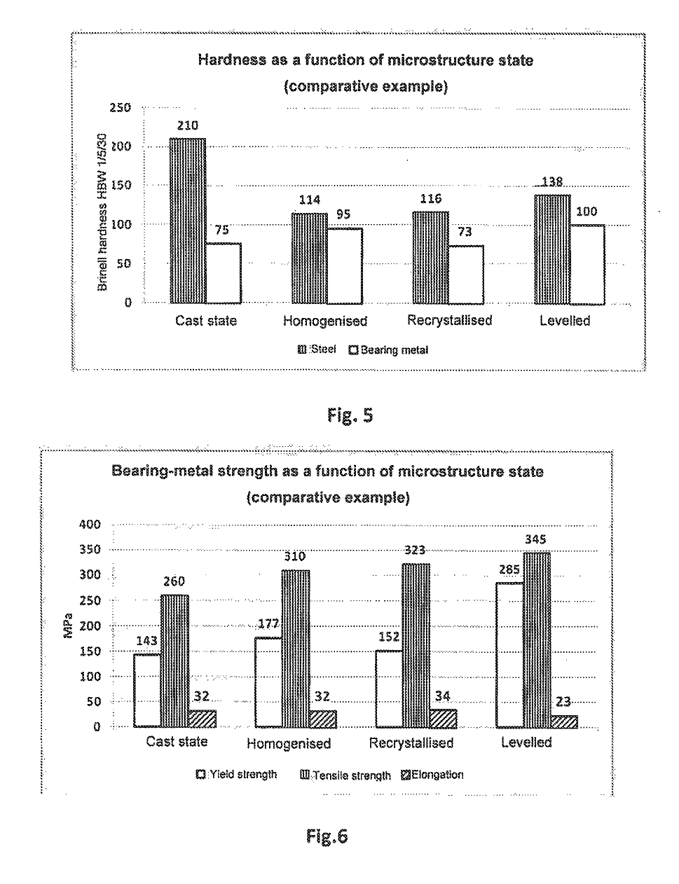

FIGS. 4a and b are perspective views of two sliding elements,

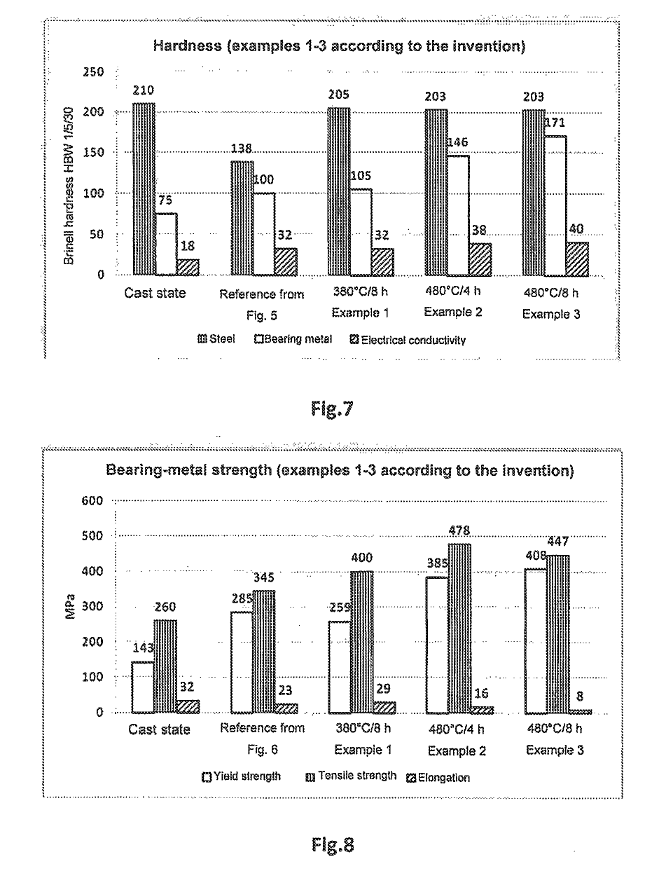

FIG. 5 is a graphic illustration of the hardness as a function of the microstructure state for a comparative example,

FIG. 6 is a graphic illustration of the bearing-metal strength as a function of the microstructure state for the comparative example,

FIG. 7 is a graphic illustration of the hardness for examples 1 to 3 according to the invention,

FIG. 8 is a graphic illustration of the bearing-metal strength for examples 1 to 3 according to the invention,

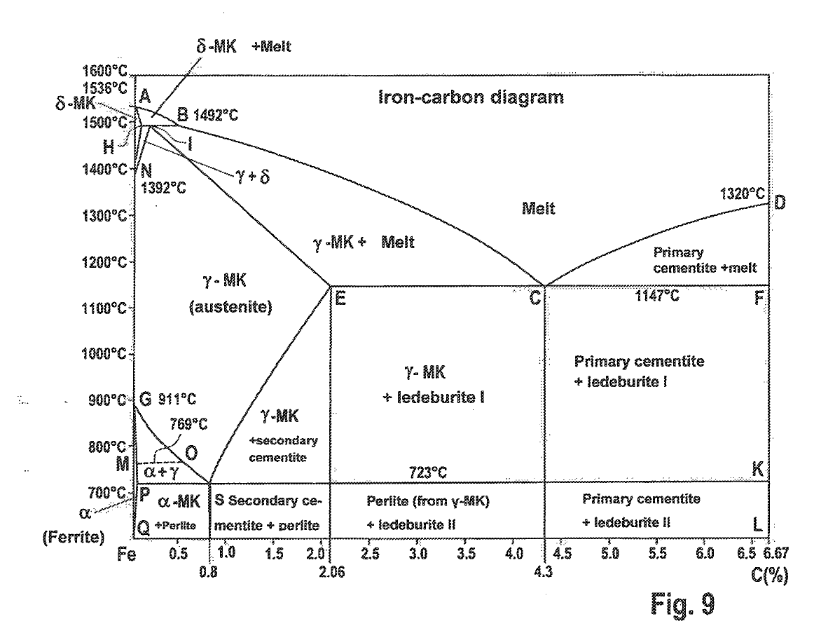

FIG. 9 is an iron-carbon diagram of steel,

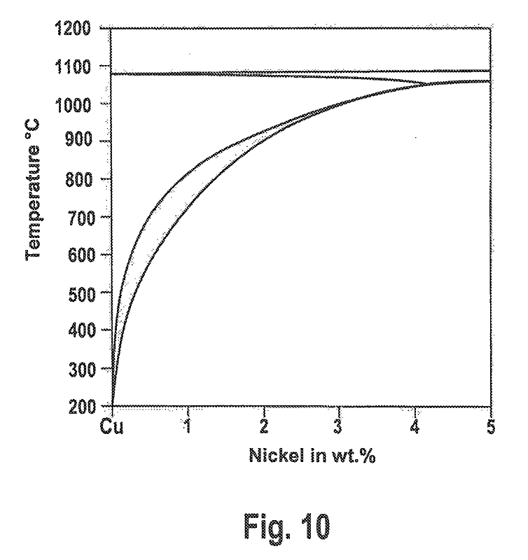

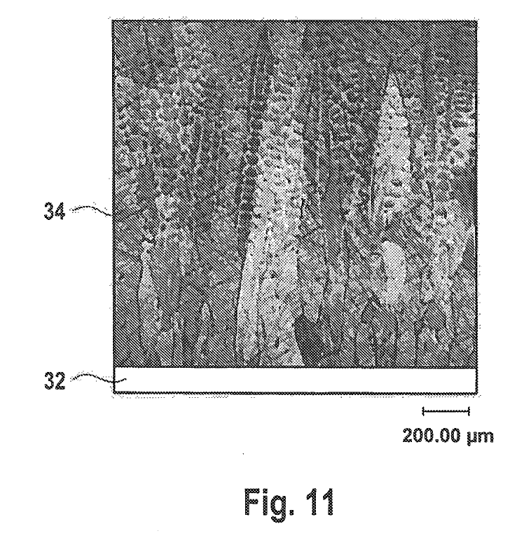

FIG. 10 is the status graph for the bearing-metal alloy CuNi2Si,

FIG. 11 is a micrograph of a cast microstructure,

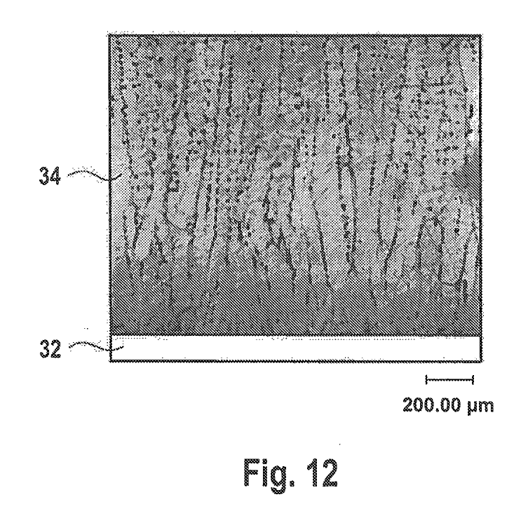

FIG. 12 is a micrograph of a dendritic microstructure of a bearing-metal layer according to Example 1,

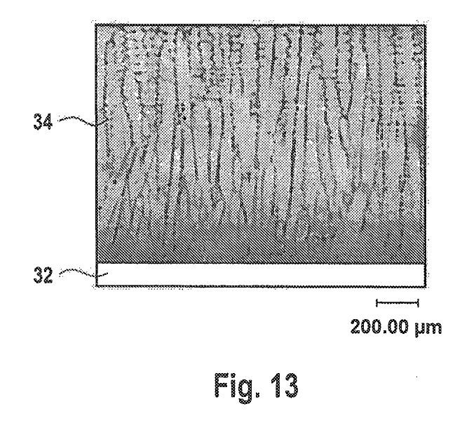

FIG. 13 is a micrograph of another dendritic microstructure of the bearing-metal layer according to Example 2,

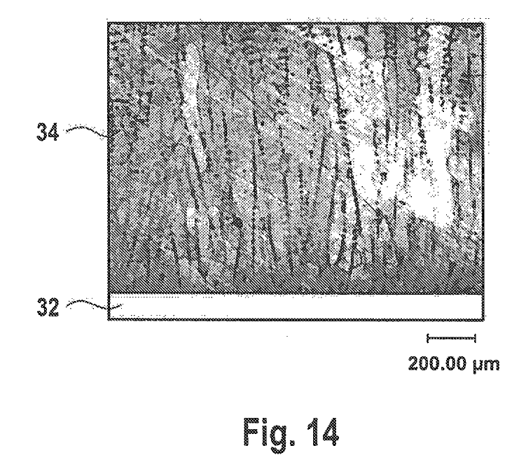

FIG. 14 is a micrograph of another dendritic microstructure of the bearing-metal layer according to Example 3.

FIG. 2 is a schematic illustration of the method sequence according to the invention, in which the temperature T of the individual method steps is plotted against time t. For example, the melt is cast onto the steel strip material at a temperature Tₘ of 1100° C. and then immediately afterwards the composite material is quenched to a temperature T₁ of around 150° C. to 250° C. The quenching process lasts around tₐ=1 to 3 min. This is followed by the aging at a temperature T_{A} of from 350° C. to 520° C. The total duration of the method t_{g2} is thus shorter than the method according to the prior art (see FIG. 1, t_{g1}). The shorter process is due to the fact that the entire homogenisation annealing step (solution annealing) is omitted.

When using CuNi2Si, for example, the prior art requires heating times of e.g. several hours to reach the target temperature of 750° C. to 800° C. as well as holding times of several hours, after which the quenching takes place.

FIG. 3 is a schematic view of a strip casting system 1. In the unwinding station 2 there is a steel strip roll 3, from which the steel strip material 6 is unwound. In a subsequent profiling station 8, the two edges 9 of the strip material 6 are bent upwards. In a heating station 10, the strip material 6 is preheated to a temperature of up to Tₒ=1050° C. by means of the heating elements 11 arranged above and below the strip material 6.

In the subsequent casting station 12, there is a melt container 13, in which the bearing-metal melt 14 is provided. In the casting station 12, the melt is cast onto the strip material 6. The composite material 25 produced is quenched in a quenching station 16 by means of the spray nozzles 17. The spray nozzles 17 are arranged below the strip material 6, and so the quenching fluid 18, which consists of cooling oil, is sprayed onto the rear side 26 of the composite material 25.

In the subsequent milling station 20, the bearing-metal surface is roughly milled away to remove the skin produced during casting or to level out the surface.

Next, the plain-bearing composite material 30 is wound up in a winding station 4. The edges 9 are used as spacers during the winding, and so the bearing-metal layer does not contact the rear side of the steel strip. This prevents the bearing metal and steel from adhering to one another. The edges 9 are not removed until later when the plain-bearing composite material is unwound again for further processing.

Next, the composite material roll 5 is brought to an aging station 24 where the final aging occurs in a bell furnace in order to set the desired mechanical properties in the bearing metal. The aging time is between 4 h and 10 h at temperatures of from 350° C. to 520° C.

The plain-bearing composite material 30 thus produced is then processed further. For example, plain-bearing shells can be produced therefrom by deformation. FIG. 4a shows a sliding element 40 in the form of a plain-bearing shell 42. The plain-bearing shell 42 comprises a steel substrate 32, a plain-bearing metal layer 34 and a sliding layer 36. The structure of the valve plate 44 shown in FIG. 4b has a steel back 32 together with the bearing-metal layer 43 produced according to the invention. In such applications, a sliding layer 36 is generally not included for stress reasons. The thickness D₁ may be between 1.5 mm and 8 mm. The bearing-metal thickness D₂ is from 0.5-3.0 mm.

### Comparative Example

A plain-bearing composite material consisting of C22+CuNi2Si was produced, the production method according to DE 10 2005 063 324 B4 being carried out as follows:
casting
homogenisation annealing at T=700° C. over 5 h
rolling
recrystallisation annealing at T=550° C. over 3 h
levelling (rolling step involving low deformation (max. 5%) used to adjust the hardness of steel and bearing metal within a defined window).

FIG. 5 shows the hardness values for the steel and the bearing metal following casting, homogenisation annealing, recrystallisation annealing and levelling.

At the end of the production method, the plain-bearing composite material has a steel hardness of 138 HBW 1/5/30 and a bearing-metal hardness of 100 HBW 1/5/30. FIG. 6 shows the corresponding strength values. The electrical conductivity is stated in IACS units.

### Examples According to the Invention

If higher strengths of both steel and bearing metal are required for certain applications, i.e. applications in which the main requirements are resistance to wear and fatigue, this can be achieved by the method according to the invention. The method according to the invention was also carried out on the same materials: steel C22 and bearing metal CuNi2Si:
bearing-metal melt cast onto a steel strip, Tₘ=1100° C.,
material quenched from 1100° C. to 300° C. i.e. 800° C. in 0.6 min, corresponding to a quenching rate of 22 K/s.

After casting, the steel is quenched from the austenite area (see FIG. 9) by the rapid cooling and hardened.

After the rapid solidification (see FIG. 10) and due to the high cooling rate, the bearing metal CuNi2Si, applied in liquid form, is present as a supersaturated α-mixed crystal, has low strength and very high elongation at break values (see FIG. 8, Cast state).

Afterwards, the plain-bearing composite material does not undergo any homogenisation annealing, but rather undergoes aging at temperatures of 380° C./8 h (example 1), 480° C./4 h (example 2) or 480° C./8 h (example 3), i.e. aging in the two-phase area of the CuNi2Si alloy (see FIG. 10), as a result of which nickel silicides form in the α-mixed crystal, leading to a significant rise in the hardness of the bearing metal. Although the hardnesses of the steels reduce slightly as a result, they remain considerably higher than in the comparative example (see FIG. 7).

FIG. 8 shows the corresponding strength values.

FIG. 11 is a micrograph of the cast state of the bearing-metal layer 34 following the quenching process according to the invention. As a result of the rapid solidification (quenching), the microstructure has a highly pronounced dendritic structure and is present as a supersaturated mixed crystal.

FIG. 12 is a micrograph of the bearing-metal layer 34 following aging according to example 1.

FIG. 13 is a micrograph of the bearing-metal layer 34 according to example 2. The stems of the dendrites extend perpendicularly to the plane of the substrate 32 and precipitates have formed in the matrix of the bearing metal, which lead to increased hardness.

FIG. 14 is a micrograph of the bearing-metal layer 34 according to example 3.

### LIST OF REFERENCE SIGNS

1 strip casting system
2 unwinding station
3 steel strip roll
4 winding station
5 composite material roll
6 steel strip material
8 profiling station
9 edge
10 preheating station
11 heating element
12 casting station
13 melt container
14 bearing-metal melt
15 solidified bearing-metal layer
16 quenching station
17 spray nozzle
18 quenching fluid
20 milling station
24 aging station
25 composite material
26 rear side of the composite material
30 plain-bearing composite material
32 substrate
34 bearing-metal layer
36 sliding layer
40 plain-bearing element
42 plain-bearing shell
44 valve plate
D₁ steel layer thickness
D₂ bearing-metal layer thickness
T₀ preheating temperature
T_{M} melt temperature
T₁ temperature following quenching
T_{A} aging temperature
t_{A} quenching time
T_{G1} total duration of the method according to the prior art
t_{G2} total duration of the method according to the invention

1. A method for producing plain-bearing composite materials, a bearing-metal melt being cast onto a strip material made of a steel and the composite material consisting of the strip material and bearing metal then undergoing a heat treatment, wherein after the bearing metal has been cast, the composite material is quenched and then an aging process is carried out subsequently.

2. The method according to claim 1, wherein the aging process is carried out over four to ten hours at a temperature of between 350° C. and 520° C.

3. The method according to claim 2, wherein the aging process is carried out at a temperature of between 350° C. and 420° C.

4. The method according to claim 2, wherein the aging process is carried out at a temperature of between >420° C. and 520° C.

5. The method according to claim 1 wherein an austenitic steel is used as the steel.

6. The method according to claim 1, wherein a steel having a carbon content of 0.15% to 0.40% is used.

7. The method according to claim 1, wherein a bearing metal consisting of a copper alloy is cast.

8. The method according to claim 7, wherein the copper alloy is precipitation hardenable.

9. The method according to claim 7, wherein the copper alloy consists of a copper-nickel alloy, a copper-iron alloy, a copper-chromium alloy or a copper-zirconium alloy.

10. The method according to claim 1, wherein the quenching process begins immediately after the casting process.

11. The method according to claim 1, wherein the quenching process begins within 15 to 25 seconds after the casting process.

12. The method according to claim 1, wherein the composite material is quenched to a temperature T₁ of from 150° C. to 250° C.

13. The method according to claim 1, wherein the quenching process is carried out at a quenching rate of from 10 K/s to 30 K/s.

14. The method according to claim 1, wherein the copper-nickel alloy is quenched at a quenching rate of from 15 K/s to 25 K/s.

15. The method according to claim 1, wherein the copper-iron alloy is quenched at a quenching rate of from 15 K/s to 25 K/s.

16. The method according to claim 1, wherein the copper-chromium alloy is quenched at a quenching rate of from 10 K/s to 20 K/s.

17. The method according to claim 1, wherein the copper-zirconium alloy is quenched at a quenching rate of from 10 K/s to 20 K/s.

18. The method according to claim 1, wherein the quenching is carried out by means of a quenching fluid.

19. The method according to claim 18, where a cooling oil is used for the quenching.

20. The method according to claim 1, wherein the quenching fluid is sprayed onto the rear side of the composite material.

21. A plain-bearing composite material comprising a steel substrate and a bearing-metal layer consisting of a cast copper alloy, wherein the bearing-metal layer has a dendritic microstructure.

22. The plain-bearing composite material according to claim 21, wherein the substrate has a hardness of from 150 HBW 1/5/30 to 250 HBW 1/5/30.

23. The plain-bearing composite material according to claim 21 wherein the bearing-metal layer has a hardness of from 100 HBW 1/5/30 to 200 HBW 1/5/30.

24. The plain-bearing composite material according to claim 21, wherein the bearing-metal layer has a tensile strength of from 380 MPa to 500 MPa.

25. The plain-bearing composite material according to claim 21, wherein the bearing-metal layer has a yield strength of from 250 MPa to 450 MPa.

26. The plain-bearing composite material according to claim 21, wherein the copper alloy is a copper-nickel alloy, a copper-iron alloy, a copper-chromium alloy or a copper-zirconium alloy.

27. The plain-bearing composite material according to claim 21, wherein the copper-nickel alloy comprises 0.5 to 5 wt. % nickel.

28. The plain-bearing composite material according to claim 21, wherein the copper-iron alloy comprises from 1.5 to 3 wt. % iron.

29. The plain-bearing composite material according to claim 21, wherein the copper-chromium alloy comprises from 0.2 to 1.5 wt. % chromium.

30. The plain-bearing composite material according to claim 21, wherein the copper-zirconium alloy comprises 0.02 to 0.5 wt. % zirconium.

31. The plain-bearing element comprising a plain-bearing composite material according to claim 21.

32. The plain-bearing element according to claim 31, wherein a sliding layer applied to the bearing-metal layer.

33. The plain-bearing element according to claim 32, wherein the sliding layer consists of a galvanic layer.

34. The plain-bearing element according to claim 33, wherein the galvanic layer consists of a tin-copper alloy, a bismuth-copper alloy or of bismuth.

35. The plain-bearing element according to claim 32, wherein the sliding layer consists of a plastic layer.

36. The plain-bearing element according to claim 32, wherein the sliding layer consists of a layer applied by means of PVD processes.

37. The lain-bearing element according to claim 32, wherein the sliding layer consists of a sputtered layer.

38. The plain-bearing element according to claim 32, wherein the plain-bearing element is formed as a plain-bearing shell, a valve plate or a sliding segment.
